(19) United States
(12) Patent Application Publication
(10) Pub. No.: US 2006/0005184 A1
(43) Pub. Date: Jan. 5, 2006

(54) Virtualizing management hardware for a virtual machine

(76) Inventors: Vijay Tewari, Portland, OR (US); Rajesh Madukkarumukumana, Portland, OR (US); Yasser Rasheed, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/880,929

(22) Filed: Jun. 30, 2004

(51) Int. Cl. G06F 9/455

(52) U.S. Cl. 718/1

(57) ABSTRACT

A system management request for a system management function is received from a virtual machine. A successful status is returned to the virtual machine in response to the system management request. A system management function is performed in response to the system management request and an aggregation of other system management requests directed to the system management function made by other virtual machines.

### BACKGROUND

A Virtual Machine (VM) is an efficient, isolated duplicate of a real computer system. Typically, a Virtual Machine Monitor (VMM) may be a thin layer of software running on a computer and presenting to other software an abstraction of one or more VMs. Each VM, may function as a self-contained platform, running its own operating system (OS), or a copy of the OS, and/or a software application. Software executing within a VM is collectively referred to as “guest software” or “VM software.” More than one VM may be provided concurrently by a single real system. A real system may have a number of resources that it provides to an operating system or application software for use. The central processing unit (CPU), also referred to as the processor, and motherboard chipset may provide a set of instructions and other foundational elements for processing data, memory allocation and input/output (I/n) handling. The real system may further include hardware devices and resources such as memory, video, audio, disk drives, and ports (universal serial bus, parallel, serial).

One class of hardware devices that may be provided by a real system is hardware platform management devices, which may be referred simply as management devices in the description of embodiments of this invention. Management devices control the operation of the system itself as opposed to handling data in furtherance of the processing objectives of programs being executed by the system. Examples of management devices include power management for the computing platform and performance monitoring of the platform.

In a real system, software such as the operating system may issue instructions to the management devices to adjust the operation of the computing platform based on the computing requirements as determined by the software. For example, if an operating system determines that there are no tasks that are ready for execution, the operating system may issue instructions to cause the computing platform to go into a standby state that consumes less power but which will require a period of time to resume normal operation when a task is ready to execute.

When a system is hosting a virtual machine environment, one or more guest software applications may be executed by the CPU in such a manner that each guest software application (guest) can execute as though it were executing with exclusive control of the system. This may require that the CPU execute a Virtual Machine Monitor (VMM) along with the guest to prevent the guest from altering the state of the system in a way that would conflict with the execution of other guests. The VMM may be referred to as the monitor. The VMM may be provided as software, firmware, hardware, or a combination of two or more of these.

Instructions directed to management devices by a VM could alter the state of the system and create conflicts with other guests. Therefore, the VMM may block instructions from a VM directed to management devices. Management devices do not lend themselves to typical techniques for virtualization such as creating a virtual device that maintains the hardware state expected by a virtual machine. Using a virtual management device would allow a virtual platform state to be maintained and reported to the associated virtual machine, but this would be largely meaningless since no real management of the platform would occur. In some prior art systems, the VMs may be created without management devices to sidestep the issue of virtualizing these devices.

### BRIEF DESCRIPTION OF THE DRAWINGS

FIG. 1 is a block diagram of a computer system that embodies the invention.

FIG. 2 is a block diagram of a VMM and VMs loaded in a random access memory of the computer system shown in FIG. 1.

FIGS. 3A-3D shows exemplary virtual management hardware states with changes over time.

FIG. 4 illustrates another embodiment of the invention using a management virtual machine.

FIG. 5 is a flowchart for an exemplary method that may be used to virtualize a system management function.

FIG. 6 is a flowchart for an exemplary method that may be used to aggregate a plurality of virtual management hardware states.

FIG. 7 is a flowchart for an exemplary method that may be used to virtualize a system management function using a management virtual machine.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

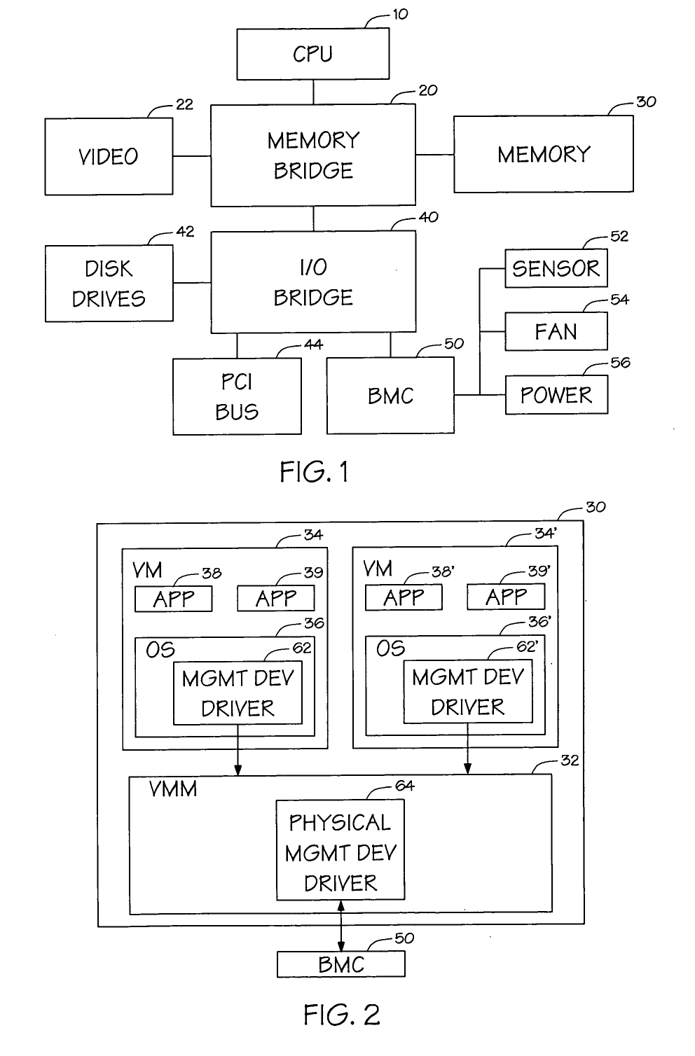

As shown in FIG. 1, a computer system may include a central processing unit (CPU) 10, also referred to as a processor, coupled to a random access memory (RAM) 30. The term CPU is intended to include a Hyper Thread, a core, or a complete processor, such as a symmetric multi-processor (SMP) host. A memory bridge 20 may couple the processor 10 to the memory 30. The RAM may be any of a variety of types of memory such as synchronous dynamic random access memory (SDRAM), RAMBUS® dynamic random access memory (RDRAM), or extended data out random access memory (EDO RAM).

The computer system may include a number of devices that are coupled to the processor 10. A video device 22 may provide a visual display that may receive data from the processor 10 through the memory bridge 20. The memory bridge may also be coupled to an I/O bridge 40. The I/O bridge may be coupled in turn to various devices such as disk drives 42, a Peripheral Component Interconnect (PCI) bus 44 that support various expansion cards, and a Baseboard Management Controller (BMC) 50. The BMC may provide communication with management devices for the computing platform such as temperature sensors 52, fans 54, and power management devices 56.

The RAM 30 may be loaded with data that represents executable instructions that may be executed by the processor 10. The RAM 30 may further contain locations that are defined to the processor 10 to contain data structures used by the processor to control the execution of the processor such as pointers to routines to be executed when certain conditions are detected, data structures such as push down stacks to temporarily hold data being used by the processor, and other data structures to define the processing environment such as task contexts. It will be understood that the amount of RAM 30 accessible by the processor 10 may exceed the amount of RAM that is physically present in the computer system. Various memory management techniques may be used to manipulate the contents of the physical RAM 30 so that it appears to the processor 10 that all of the accessible RAM is present. The contents of the RAM 30 will be described as though all accessible RAM is physically present to avoid obscuring the operation of the described embodiments of the invention but it should be understood that the structures described as being in memory may not all be in physical memory concurrently and that different memory structures may occupy the same physical memory successively while remaining logically distinct.

The processor 10 may be used to host one or more virtual machines (VMs). As shown in FIG. 2, a portion of RAM 30 may be assigned to each virtual machine 34 as a virtual machine context. The assigned portion of RAM 30 may be all or part of the RAM available to the processor 10. The assigned portion of RAM 30 may be loaded and unloaded as required to allow one virtual machine 34 to use some or all of the physical RAM assigned to another virtual machine 34′. The RAM 30 may support a virtual memory system to manage the use of the RAM so that each virtual machine 34 is able to use the RAM without regard to other virtual machines 34′ that might also be hosted by the processor 10. The processor may host a Virtual Machine Monitor (VMM) 32 to manage the one or more virtual machines 34. The VMM 32 may trap the execution of certain instructions by the virtual machines 34 so that each virtual machine 34 is able to operate without regard to other virtual machines 34′ that might also be hosted by the processor 10.

Each virtual machine 34 provides an environment for the execution of software that appears to be a dedicated physical machine that is protected and isolated from other virtual machines 34′. While only two virtual machines are shown, it is to be understood that any number of virtual machines may be hosted by the processor used in embodiments of the invention. Each virtual machine 34 may have an operating system (OS) 36 and one or more application programs 38, 39 that are executed by the OS. The OS 36 on each virtual machine 34 may be the same or different that the OS on other virtual machines.

The OS 36 on one or more of the VMs 34 may include a management device driver 62 for the purpose of issuing commands and receiving status for platform management functions. The VMM 32 may virtualize the platform management functions so that it appears that the virtual machine 34 has control of the platform functions and so that the manipulation of platform functions by one virtual machine 34 do not interfere with other virtual machines 34′ that may be executing on the same underlying system.

The VMM 32 may configure the processor 10 so that instructions issued by the VM 34 to manipulate platform functions are trapped to the VMM. The VMM may perform the system management function in response to the system management request by the virtual machine 34 and an aggregation of other system management requests directed to the system management function made by other virtual machines 34′.

The VMM may return a successful status to the virtual machine in response to the system management request. In another embodiment, the VMM may return a status based on the results of the system management function as performed by the VMM. For example, if the VM 34 issues a system management request to turn on a fan and the fan fails to turn on, then a failed status may be returned to the VM. The VMM may return a status based on an earlier performed system management function. For example, if the VM 34 issues a system management request to turn on a fan and an attempt to turn on the fan previously failed, then a failed status may be returned to the VM without another attempt to turn on the fan.

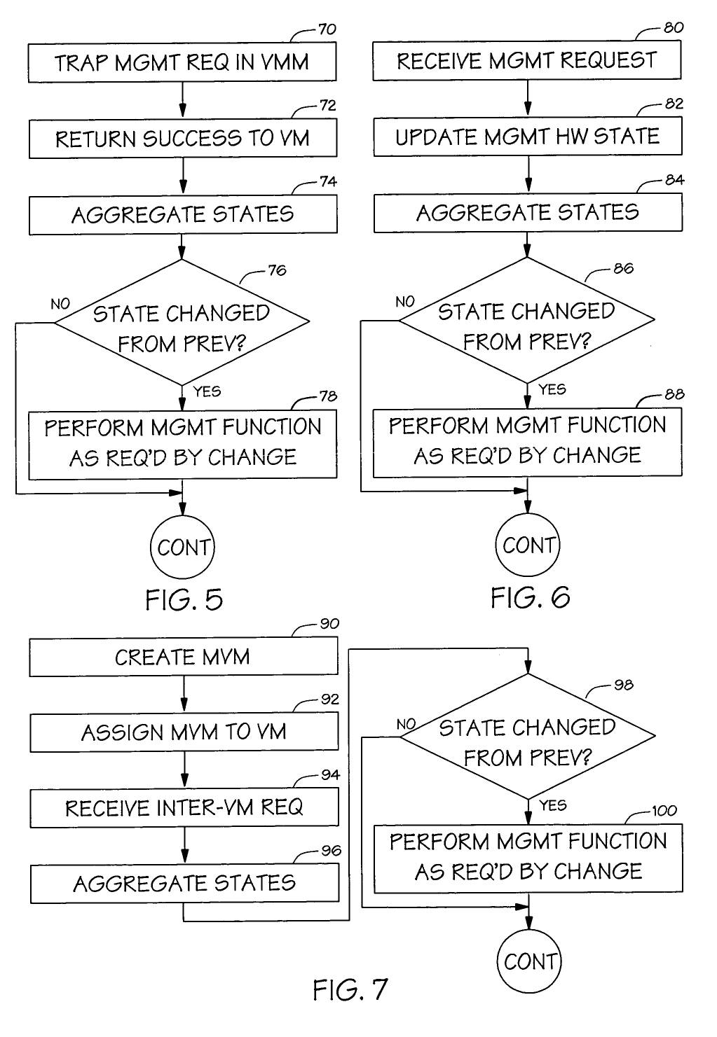

FIG. 5 is a flowchart for an exemplary method that may be used to virtualize a system management function. A system management request for the system management function is received from a virtual machine 70, such as by being trapped to a virtual machine monitor. A successful status is returned 72 to the virtual machine in response to the system management request. The system management request and other system management requests directed to the system management function made by other virtual machines are aggregated 74. If the aggregation of the system management request and the other system management requests indicates that a change of state is appropriate 76-YES, then the system management function is performed as indicated by the aggregation 78.

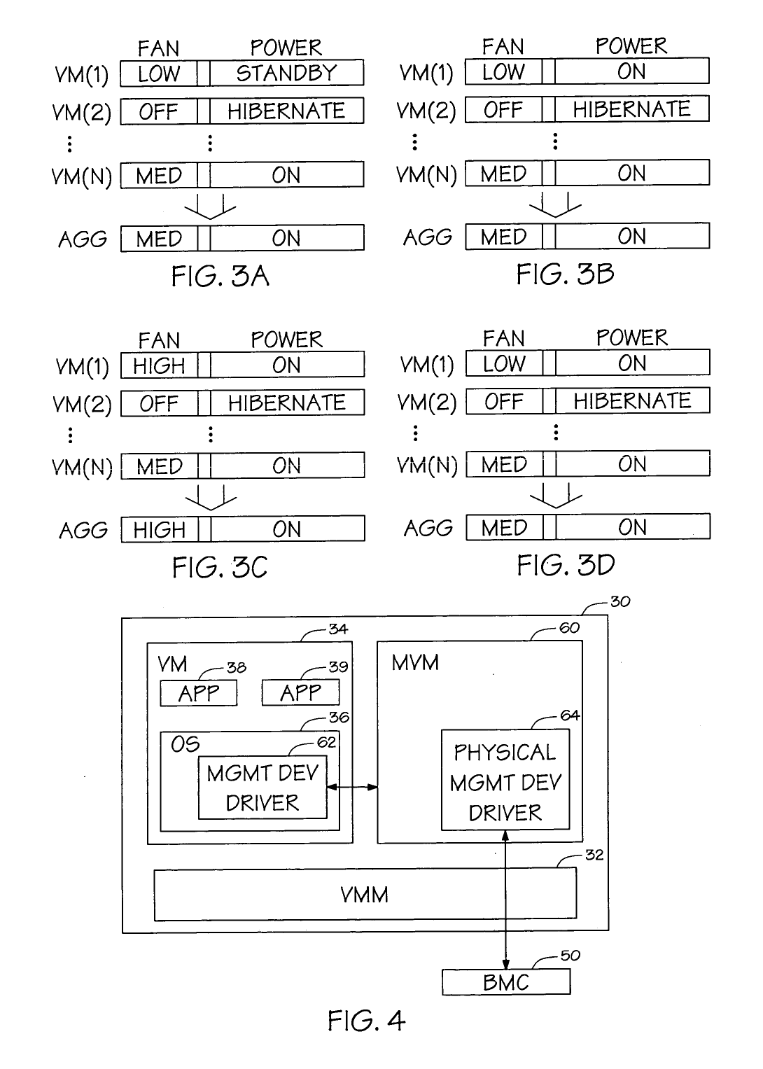

The system management requests may be aggregated by maintaining virtual management hardware states for each of a number of virtual machines, VM(1) through VM(n), as shown in FIGS. 3A through 3D which show how these states may change over time. Each virtual management hardware state is shown as including an element for a fan state and an element for a power state. It will be understood that these elements are merely exemplary and that a virtual management hardware state may include different elements than those illustrated and that there may be a different number of elements.

The plurality of virtual management hardware states may be aggregated to determine an aggregated virtual management hardware state, labeled AGG in FIGS. 3A through 3D, that provides at least the capabilities of each of the virtual management hardware states. In the example shown in FIG. 3A, the aggregate virtual management hardware state has a fan state of medium which represents the greatest cooling capability of any of the virtual management hardware states, and a power state of on which represents the greatest power capability of any of the virtual management hardware states. In this particular example, the aggregate virtual management hardware state is identical to the virtual management hardware state for virtual machine VM(n). At other times the aggregate virtual management hardware state may not be identical to the virtual management hardware state for any individual virtual machine.

FIG. 3B illustrates the change to the virtual management hardware state of VM(1) in response to virtual machine VM(1) issuing a system management request for the system management function of setting the power to on. The virtual management hardware state of VM(1) is updated as is the aggregated virtual management hardware state. In this case power of the aggregated virtual management hardware state was already on and therefore no physical system management function is required.

FIG. 3C illustrates the change to the virtual management hardware state of VM(1) in response to virtual machine VM(1) subsequently issuing a system management request for the system management function of setting the fan to high. The virtual management hardware state of VM(1) is updated as is the aggregated virtual management hardware state. In this case the fan state of the aggregated virtual management hardware state increases from medium to high, the fan state set for VM(1), and therefore a physical system management function is issued by the VMM to the management device hardware to set the fan speed to high.

FIG. 3D illustrates the change to the virtual management hardware state of VM(1) in response to virtual machine VM(1) subsequently issuing a system management request for the system management function of setting the fan to low. The virtual management hardware state of VM(1) is updated as is the aggregated virtual management hardware state. In this case the fan state of the aggregated virtual management hardware state decreases from high to medium. This is not the fan state set for VM(1), which is low, but rather the fan state previously set by VM(n) which is now the state requiring the greatest capability of the fan. A physical system management function is issued by the VMM to the management device hardware to set the fan speed to medium. Note that the physical system management function is issued in response to a system management request from VM(1) but that the physical system management function issued is determined by a previously issued system management request from VM(n). Thus the system management function is performed as required by changes in the aggregated virtual management hardware state, not necessarily as requested by the VM request that was received.

The management device policy applied by the MVM 60 may provide an aggregated virtual management hardware state that provides an aggregated hardware capability that is greater than that requested by any of the virtual machines. For example, if several VMs set the fan speed to low, the MVM may determine that a high fan speed is appropriate to handle the collective requirements of the several VMs.

FIG. 6 is a flowchart for an exemplary method that may be used to aggregate a plurality of virtual management hardware states for each of a like plurality of virtual machines, such as the states illustrated in FIGS. 3A-3D. The plurality of virtual management hardware states may be maintained as stored values, such as by maintaining an array of values in memory. Each of the plurality of virtual management hardware states may represent a capability required for an associated virtual machine. A system management request for a system management function may be received from a virtual machine 80. In response the virtual management hardware state for the virtual machine may be updated 82. The plurality of virtual management hardware states may be aggregated to determine an aggregated virtual management hardware state that provides at least the capability of each of the plurality of virtual management hardware states 84. If the aggregated virtual management hardware state is changed from the previous aggregated virtual management hardware state 86-NO, then the system management function is performed as required by the changes in the aggregated virtual management hardware state 88.

FIG. 4 illustrates another embodiment of the invention. A virtual machine may be designated as a management virtual machine (MVM) 60. The MVM may be the first virtual machine instantiated and may be dedicated to the task of controlling the system management functions. The MVM 60 may be the only virtual machine that is given access to the hardware devices 50 that provide the system management functions. The MVM may be provided direct pass through access to one or more physical hardware devices 50 that provide a system management function, such that the MVM is the sole owner of the device. The MVM 60 in conjunction with the VMM 32 can then provide a virtualized abstraction of the management device 50 to one or more VMs 34. The VMM may execute code such as code represented by the following pseudo-code to provide the MVM with exclusive access to a management device:

// inside the VMM
if (VM.ID==MVM)

| // Assign the platform | |
|---|---|
| // | management device to MVM |

AssignManagementDevice (VM.ID);

The VMM 32 may create a virtual management device when a virtual machine 34 is created as represented by the following pseudo-code:

// On creation of a VM
virtDev_Id = CreateVirtualDevice(MgtDeviceType);
AssignDevice(VMID, virtDev_Id);

This may allow an OS 36 executing on the VM 34 to provide a management device driver 62 that communicates with the MVM 60 to provide system management functions for the VM 34. Communication between the management device driver 62 and the MVM 60 may be through inter-VM communications, such as shared memory, which may provide direct communication between the VM and the MVM. Provisioning of the management device driver 62 by the OS 36 may be represented by the following pseudo-code:

| // Inside the VM | |
|---|---|
| dev_list = Enumerate_Resources( ); | |
| // Go through the device list to load drivers; | |
| // | this will load a driver for the |
| // | virtual management device |

load_driver(dev_list[index].devi_type);
// Now use the device as normal

A request to change the state of a management device from the management device driver 62 may cause the MVM 60 to unconditionally return a successful status as described above and as represented by the following pseudo-code:

| // On receiving a request to change | |
|---|---|
| // | management device state by |
| // | the management device driver |

| | |
|---|---|
| ChangeVirtualState( ); | // MVM returns success |

The MVM 60 may consult with the policy in effect for the current environment, such as the aggregation policy described above, and pass the appropriate state to the physical hardware 50 as represented by the following pseudo-code:

// Inside the MVM
ApplyManagementDevPolicy( );

FIG. 7 is a flowchart for an exemplary method that may be used to virtualize a system management function using a management virtual machine. A management virtual machine is created that is enabled to perform system management functions 90. The management device hardware is assigned to the MVM.

The VMM then provides a virtual management device to each of the VMs as they are created. The management virtual machine is assigned to a virtual machine as a virtual management device upon creation of the virtual machine 92.

When a VM issues a system management request to make a change in the state of the management device in the VM, the request is received by the MVM 94. The system management request may be passed to the VMM. Since the VMM has virtualized the management device, the VMM may forward this request to the MVM which actually now owns the management device. In another embodiment, the VMs system management device driver is configured to direct the system management request so that it is directly received by the MVM through inter-VM communication.

The MVM then aggregates the states from all the VMs as set by the system management request and other system management requests previously made by other VMs to determine what modifications, if any, are actually required in the physical hardware 96. If the aggregation of the system management request and the other system management requests indicates that a change of state is appropriate 98-YES, then the system management function is performed as indicated by the aggregation 100.

It will be appreciated that embodiments of the invention may be in the form of an article of manufacture that includes a machine-accessible medium. The machine-accessible medium may include data that, when accessed by a processor 10, cause the processor to perform operations. Thus, a machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.); etc.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method for virtualizing a system management function, the method comprising:
receiving a system management request for the system management function from a virtual machine;
performing the system management function in response to an aggregation of the system management request and previously received system management requests made by other virtual machines.

2. The method of claim 1, wherein the system management request is received by being trapped to a virtual machine monitor.

3. The method of claim 1, further comprising:
creating a management virtual machine that is enabled to perform system management functions;
creating the virtual machine;
assigning the management virtual machine to the virtual machine as a virtual management device upon creation of the virtual machine.

4. The method of claim 3, wherein:
the system management request is received by the management virtual machine through inter-VM communication;
the system management function is performed by a hardware system management request issued by the management virtual machine.

5. The method of claim 3, wherein the system management request for the system management function is a virtual management request for a virtual management function that corresponds to the system management function, and the virtual management request is communicated directly to the management virtual machine.

6. The method of claim 1, wherein performing the system management function is conditional on the aggregation of the system management request and the other system management requests indicating that a change of state is appropriate.

7. The method of claim 1, further comprising:
maintaining a plurality of virtual management hardware states for each of a like plurality of virtual machines, each of the plurality of virtual management hardware states representing a capability required for an associated virtual machine;
updating the virtual management hardware state for the virtual machine responsive to the system management request for the system management function from the virtual machine;
aggregating the plurality of virtual management hardware states to determine an aggregated virtual management hardware state that provides at least the capability of each of the plurality of virtual management hardware states;
wherein the system management function is performed as required by changes in the aggregated virtual management hardware state.

8. The method of claim 1, further comprising:
returning a successful status to the virtual machine in response to the system management request;

9. A system comprising:
a processor;
a hardware platform management device coupled to the processor; and
a memory coupled to the processor, the memory including data that, when accessed by the processor, cause the processor to perform operations comprising,
receiving a system management request for the system management function from a virtual machine;
performing the system management function in response to an aggregation of the system management request and previously received system management requests made by other virtual machines.

10. The system of claim 9, wherein the system management request is received by being trapped to a virtual machine monitor.

11. The system of claim 9, wherein the memory further includes data that, when accessed by the processor, cause the processor to perform further operations comprising:
creating a management virtual machine that is enabled to perform system management functions;
creating the virtual machine;
assigning the management virtual machine to the virtual machine as a virtual management device upon creation of the virtual machine.

12. The system of claim 11, wherein:
the system management request is received by the management virtual machine through inter-VM communication;
the system management function is performed by a hardware system management request issued by the management virtual machine.

13. The system of claim 11, wherein the system management request for the system management function is a virtual management request for a virtual management function that corresponds to the system management function, and the virtual management request is communicated directly to the management virtual machine.

14. The system of claim 9, wherein performing the system management function is conditional on the aggregation of the system management request and the other system management requests indicating that a change of state is appropriate.

15. The system of claim 9, wherein the memory further includes data that, when accessed by the processor, cause the processor to perform further operations comprising:
maintaining a plurality of virtual management hardware states for each of a like plurality of virtual machines, each of the plurality of virtual management hardware states representing a capability required for an associated virtual machine;
updating the virtual management hardware state for the virtual machine responsive to the system management request for the system management function from the virtual machine;
aggregating the plurality of virtual management hardware states to determine an aggregated virtual management hardware state that provides at least the capability of each of the plurality of virtual management hardware states;
wherein the system management function is performed as required by changes in the aggregated virtual management hardware state.

16. The system of claim 9, wherein the memory further includes data that, when accessed by the processor, cause the processor to perform further operations comprising:
returning a successful status to the virtual machine in response to the system management request;

17. An article of manufacture comprising:
a machine-accessible medium including data that, when accessed by a processor, cause the processor to perform operations comprising,
receiving a system management request for the system management function from a virtual machine;
performing the system management function in response to an aggregation of the system management request and previously received system management requests made by other virtual machines.

18. The article of manufacture of claim 17, wherein the system management request is received by being trapped to a virtual machine monitor.

19. The article of manufacture of claim 17, wherein the machine-accessible medium further includes data that, when accessed by the processor, cause the processor to perform further operations comprising:
creating a management virtual machine that is enabled to perform system management functions;
creating the virtual machine;
assigning the management virtual machine to the virtual machine as a virtual management device upon creation of the virtual machine.

20. The article of manufacture of claim 19, wherein:
the system management request is received by the management virtual machine through inter-VM communication;
the system management function is performed by a hardware system management request issued by the management virtual machine.

21. The article of manufacture of claim 19, wherein the system management request for the system management function is a virtual management request for a virtual management function that corresponds to the system management function, and the virtual management request is communicated directly to the management virtual machine.

22. The article of manufacture of claim 17, wherein performing the system management function is conditional on the aggregation of the system management request and the other system management requests indicating that a change of state is appropriate.

23. The article of manufacture of claim 17, wherein the machine-accessible, medium further includes data that, when accessed by the processor cause the processor to perform further operations comprising:
maintaining a plurality of virtual management hardware states for each of a like plurality of virtual machines, each of the plurality of virtual management hardware states representing a capability required for an associated virtual machine;
updating the virtual management hardware state for the virtual machine responsive to the system management request for the system management function from the virtual machine;
aggregating the plurality of virtual management hardware states to determine an aggregated virtual management hardware state that provides at least the capability of each of the plurality of virtual management hardware states;
